(19) United States
(12) Patent Application Publication
(10) Pub. No.: US 2016/0061582 A1
(43) Pub. Date: Mar. 3, 2016

(54) SCALE ESTIMATING METHOD USING SMART DEVICE AND GRAVITY DATA

(71) Applicant: LUSEE, LLC, Pittsburgh, PA (US)

(72) Inventors: Simon Michael Lucey, Brisbane (AU); Christopher Charles Willoughby Ham, Brisbane (AU); Surya P. N. Singh, Brisbane (AU)

(73) Assignee: LUSEE, LLC, Pittsburgh, PA (US)

(21) Appl. No.: 14/469,595

(22) Filed: Aug. 27, 2014

Related U.S. Application Data
(62) Division of application No. 14/469,569, filed on Aug. 26, 2014.

(51) Int. Cl. G01B 11/02; H04N 7/18

(52) U.S. Cl. CPC G01B 11/022; H04N 7/183

(57) ABSTRACT

A scale estimating method through metric reconstruction of objects using a smart device is disclosed, in which the smart device is equipped with a camera for image capture and an inertial measurement unit (IMU). The scale estimating method is adapting a batch, vision-centric approach only using IMU to estimate the metric scale of a scene reconstructed by algorithm with Structure from Motion like (SfM) output. Monocular vision and noisy IMU can be integrated with the disclosed scale estimating method, in which a 3D structure of an object of interest up to an ambiguity in scale and reference frame can be resolved. Gravity data and a real-time heuristic algorithm for determining sufficiency of video data collection are utilized for improving upon scale estimation accuracy so as to be independent of device and operating system. Application of the scale estimation includes determining pupil distance and 3D reconstruction using video images.

### BACKGROUND OF THE INVENTION

1. Field of the Invention

The invention generally relates to a scale estimating method, in particular to a scale estimating method using a smart device configured with an IMU and a camera, which uses gravity data in temporal alignment of IMU and camera signals, and a scale estimation system using the same.

2. Description of Prior Art

There have been several methods being developed to obtain a metric understanding of the world by means of monocular vision using a smart device that do not require an inertial measurement unit (IMU). Such conventional measurement methods all centered on the idea of obtaining a metric measurement of something already observed by the vision algorithm and propagating the corresponding preexisting scale. There are a number of apps available in the marketplace which achieve the above functionality using vision capture technology. However, these apps all require an external reference object of known true structural dimensions to perform scale calibration prior to estimating a metric scale value on an actual object of interest. Usually a credit card of known physical dimensions or a known measured height of the camera from the ground (assuming the ground is flat) can be served as the external calibration object, respectively.

The computer vision community traditionally has not found an effective solution for obtaining a metric reconstruction of objects in 3D space when using monocular or multiple uncalibrated cameras. This deficiency is well founded since Structure from Motion (SfM) dictates that a 3D object/scene can be reconstructed up to an ambiguity in scale. In other words, it is impossible based on the images in 3D space alone to estimate the absolute scale of the scene (i.e. the height of a house, when the object of interest is adjacent to the house) due to unavoidable presence of scale ambiguity. More and more smart devices (phones, tablets, etc.) are low cost, ubiquitous and packaged with more than just a monocular camera for sensing the world. Even digital cameras are being bundled with a plethora of sensors, such as GPS (global positioning system) sensor, light sensor for detecting light intensity, and IMUs (inertial measurement units).

Furthermore, the idea of combining measurements of an IMU and a monocular camera to make metric sense of the world has been well explored by the robotics community. Traditionally, however, the robotics community has focused on odometry and navigation applications, which requires accurate and thus expensive IMUs while using vision capture largely in a peripheral manner. Meanwhile, IMUs on modern smart devices, in contrast, are used primarily to obtain coarse measurements of the velocity, orientation, and gravitational forces being applied to the smart device for the purposes of enhancing user interaction and functionalities. As a consequence, overall costs can be dramatically reduced by relying on the modern smart devices for performing metric reconstruction of objects of interest under 3D space when using monocular or multiple uncalibrated cameras of such smart devices. However, on the other hand, such scale reconstruction usage has to rely on using noisy and less accurate sensors, so there are potentially accuracy tradeoffs that require to be taken into consideration.

In addition, most conventional smart devices do not synchronize data gathered from the IMU and video captures. If the IMU and video data inputs are not sufficiently aligned, the scale estimation accuracy in practice is severely degraded. Referring to FIG. 1, it is evident that a lack of having accurate metric scale information not only introduces ambiguities in SfM type applications, but also in other common tasks in vision recognition such as object detection, as well. For example, a standard object detection algorithm is employed to detect a toy dinosaur in a visual scene as shown in FIG. 1. However, because there are two such toy dinosaurs of similar features but of different sizes in FIG. 1, therefore, the object detection task becomes not only to detect and distinguish the specific type of object being detected, i.e. a toy dinosaur, but also to disambiguate between two similar toy dinosaurs that differ only in scale/size. Unless the video image capture contains both toy dinosaurs standing together within the same image frame with at least one of the toy dinosaur having known dimensions, as shown in FIG. 1, or standing together with some other reference object of known dimensions, there would be no simple way visually to distinguish the respective dimensions and scales of the two toy dinosaurs of different sizes. Similarly, a pedestrian detection algorithm could likewise distinguish that a toy doll is not a real person. In biometric applications, an extremely useful biometric trait for recognizing or separating different people is by means of the scale of the head (by means of e.g. pupil distance), which goes largely unused by current facial recognition algorithms. Therefore, there is room for improvement in the related art.

### SUMMARY OF THE INVENTION

An objective of the present invention is to provide a batch-style scale estimating method using a smart device configured with a IMU and a monocular camera integrated with vision algorithm that is able to obtain SfM style camera motion matrices, in which a gravity data is collected and being used in a temporal alignment method of the camera and IMU signals to perform metric scale estimation on an object of interest up to an ambiguity in scale and reference frame in 3D space.

To achieve above objectives, the temporal alignment method of the IMU data and the video data captured by the monocular camera is provided to enable the scale estimation method in the embodiments of present invention.

Another objective of the present invention is use the scale estimate obtained by the scale estimating method using the smart device configured with the IMU and the monocular camera together with the SfM style camera motion matrices, and along with temporally aligned camera and IMU signals by using the gravity data to perform 3D reconstruction on the object of interest so as to obtain an accurate 3D rendering thereof up to 2% error in accuracy.

Another objective of the present invention is to use the gravity data in the IMU and the monocular camera to perform the scale estimation on the object of interest.

To achieve the objective of the present invention to be using the gravity data in the IMU and the monocular camera to perform the scale estimation on the object of interest, a gravity vector, g, is added back into an estimated camera acceleration and is compared with a raw IMU acceleration (which already contains raw gravity data), and before superimposing the gravity data, raw gravity data is oriented with the IMU acceleration data, much like the camera acceleration. Raw gravity data is of relatively large magnitude and low frequency, thereby improving the robustness of the temporal alignment dramatically.

Another object of the present invention is to provide a method to solve for gravity data value, without attempting to constrain gravity to a known default constant.

To achieve the objective of solving for gravity for temporal alignment of the camera and the IMU signals, an argument of the minimum objective function is solved by alternating between solving for {s,b} and g separately where g is normalized to its known magnitude when solving for {s,b}. This is iterated until the scale estimation process converges.

In the embodiments of present invention, the usage of gravity data in the temporal alignment is independent of device and operating system, and also effective in improving upon the robustness of the temporal alignment dramatically.

Assuming that the IMU noise is largely uncorrelated and there is sufficient motion data during the collection of the video capture data, it is seen through conducted experiments that metric reconstruction of object in 3D space using the proposed scale estimation method by means of the monocular camera converges eventually towards an accurate scale estimate being achieved even in the presence of significant amounts of IMU noise. Indeed, by enabling existing vision algorithms (operating on IMU-enabled smart devices, such as, digital cameras, smart phones, etc) to make metric measurements of the world in 3D space, the metric and scale measuring capabilities can be improved upon, and new applications can be discovered by adopting the methods and system in accordance with the embodiments of the present invention.

One potential application of the embodiments of present invention is that a 3D scan of an object using a smart device can be 3D printed to precise dimensions through metric 3D reconstruction of objects using the scale estimating method combined with SfM algorithms. Other real life useful applications of the metric scale estimation method of the embodiments of present invention includes, but not limited, to be used on estimating a size of a head of person, i.e. determining pupil distance, obtaining a metric 3D reconstruction of a toy dinosaur, the height of a person, the size of furniture and other facial recognition applications, etc.

To achieve the above objectives, according to conducted experiments performed in accordance with the embodiments of the present invention, scale estimation accuracy achieved is within 1%-2% of ground-truth using just one monocular camera and the IMU of a canonical/conventional smart device.

To achieve above objectives, through recovery of scale using SfM (Structure from Motion) algorithms, or algorithms tailored for specific objects (such as faces, height, cars) in accordance with the embodiments of present invention, one can determine the 3D camera pose and scene accurately up to scale.

### BRIEF DESCRIPTION OF DRAWINGS

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a illustrative diagram showing two toy dinosaurs of similar structural features but of different sizes and scales which is difficult to discern by using just one camera.

FIGS. 2a-2b are two plotted diagrams showing a result of a normalized cross correlation of the camera and the IMU signals according to an embodiment of the present invention.

FIG. 3 is a plotted diagram showing the effect of gravity in the IMU acceleration data in an embodiment of present invention;

FIGS. 4a-4d show four different motion trajectories types used in the conducted experiments in accordance with the embodiments of present invention for producing camera motion.

FIG. 5 shows a bar chart illustrating the accuracy of the scale estimation results using l2-norm² as the penalty function and various combinations of motion trajectories for camera motion according to the first embodiment of the present invention.

FIG. 6 shows a bar chart illustrating the accuracy of the scale estimation results using grouped-l1-norm as the penalty function and various combinations of motion trajectories for camera motion according to a second embodiment of the present invention.

FIG. 7 are two diagrams illustrating convergence and accuracy of the scale estimation over time for b+c motion trajectories (In and Out and Side Ways) under temporally aligned camera and IMU signals according to the first embodiment, and convergence and accuracy of the scale estimation over time for b+c motion trajectories (In and Out and Side Ways) without temporally aligned camera and IMU signals.

FIG. 8 are diagrams showing the motion trajectory sequence b+c(X,Y, Z) excite x-axis, y-axis, and z-axis with the scaled camera acceleration and the IMU acceleration, plotted along the time duration axis.

FIG. 9 shows results of pupil distance measurements conducted at various testing times for a third embodiment of present invention.

FIG. 10 shows results of pupil distance measurements conducted at various testing times showing tracking error outliers for a fourth embodiment of present invention.

FIG. 11 shows an actual length of a toy Rex (a) compared with the length of the 3D reconstruction of the toy Rex scaled by the algorithm of the first embodiment (b).

FIG. 12 is a block diagram of a batch metric scale estimation system according to a fifth embodiment of present invention.

FIG. 13 is a flow chart of a temporal alignment method of the camera signals and the IMU signals according to the embodiments of present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The scale factor from vision units to real units is time invariant and so with the correct assumptions made about noise, an estimation of its value should converge to the correct answer with more and more data being gathered or acquired.

According to a first embodiment, a smart device is operated under moving and rotating in 3D space. In this embodiment, conventional SfM algorithm can be used in which the output thereof can be used together with a scale estimate value to arrive at metric reconstruction of an object. Most SfM algorithms will return the position and orientation of the camera of the smart device in scene coordinates, and IMU acceleration measurements from the smart device are in local, body-centric coordinates thereof. To compare the data gathered in scene coordinates with respect to the body-centric coordinates, the acceleration measured by the camera of the smart device needs to be oriented with that of the IMU for the same smart device. An acceleration matrix is defined such that each row of a is the (x,y,z) acceleration for each video frame captured by the camera, expressed in Equation 1 as follow:

$${A}_{V} = ( \begin{matrix}{a}_{1}^{x} & {a}_{1}^{y} & {a}_{1}^{z} \\ ⋮ & ⋮ & ⋮ \\ {a}_{F}^{x} & {a}_{F}^{y} & {a}_{F}^{z}\end{matrix} ) = ( \begin{matrix}{Φ}_{1}^{T} \\ ⋮ \\ {Φ}_{F}^{T}\end{matrix} ) \qquad ( 1 )$$

Then the vectors in each row are rotated to obtain the body-centric acceleration Â_{V} shown in Equation 2 below as measured by the vision algorithm:

$${\hat{A}}_{V} = ( \begin{matrix}{Φ}_{1}^{T} {R}_{1}^{V} \\ ⋮ \\ {Φ}_{F}^{T} {R}_{F}^{V}\end{matrix} ) \qquad ( 2 )$$

where F is the number of video frames, R^{V}ₙ is the orientation of the camera in scene coordinates at an nth video frame, and Φ₁^{T} to Φ_{F}^{T} are are vectors with the visual acceleration (x,y,z) at each corresponding video frame. Similarly to A_{V}, an N×3 matrix of a plurality of IMU acceleration measurements, A_{I}, is formed, where N is the number of IMU acceleration measurements. In addition, the IMU acceleration measurements need to be ensured of being spatially aligned with the camera coordinate frame. Since the camera and the IMU are configured and disposed on the same circuit board, an orthogonal transformation R_{I}, is being performed, that is determined by the API used by the smart device. The rotation is used to find the IMU acceleration in local camera coordinates. This leads to the (argument of the minimum) objective as defined in Equation 3, noting that antialiasing and downsampling have no effect on constant bias b, as follows:

$${argmin }_{s , b} η \{ s \cdot {\hat{A}}_{V} + 1 ⊗ {b}^{T} - {DA}_{I} {R}_{I} \} \qquad ( 3 )$$

where s is scale, Â_{V} is defined in Equation 2 above, D is a convolutional matrix that antialiases and down-samples the IMU data, η{ } is a penalty function; the choice of no depends on the noise characteristics of the sensor data. In many applications, this penalty function could commonly chosen to be the l2-norm², however other noise assumptions can be incorporated as well.

All constants, variables, operators, matrices, or entities included in Equation 3 which are the same as those in Equations 1-2 are defined in the same manner, and are therefore omitted for the sake of brevity.

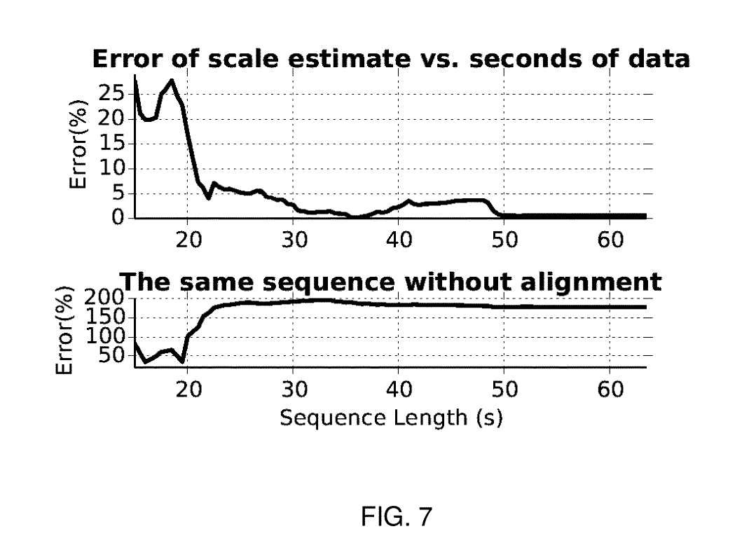

In this embodiment, temporal alignment of a plurality of camera signals and a plurality of IMU signals is taken into account. Referring to FIG. 7, which shows that scale estimation of the illustrated embodiment is not possible without temporal alignment. In Equation 2, an underlying assumption being made is that the camera and the IMU acceleration measurements are temporally aligned. However, a method to determine the delay between the camera signals and the IMU signals and thus aligning the camera signals and the IMU signals for processing can be effectively integrated into the scale estimation in the illustrated embodiment.

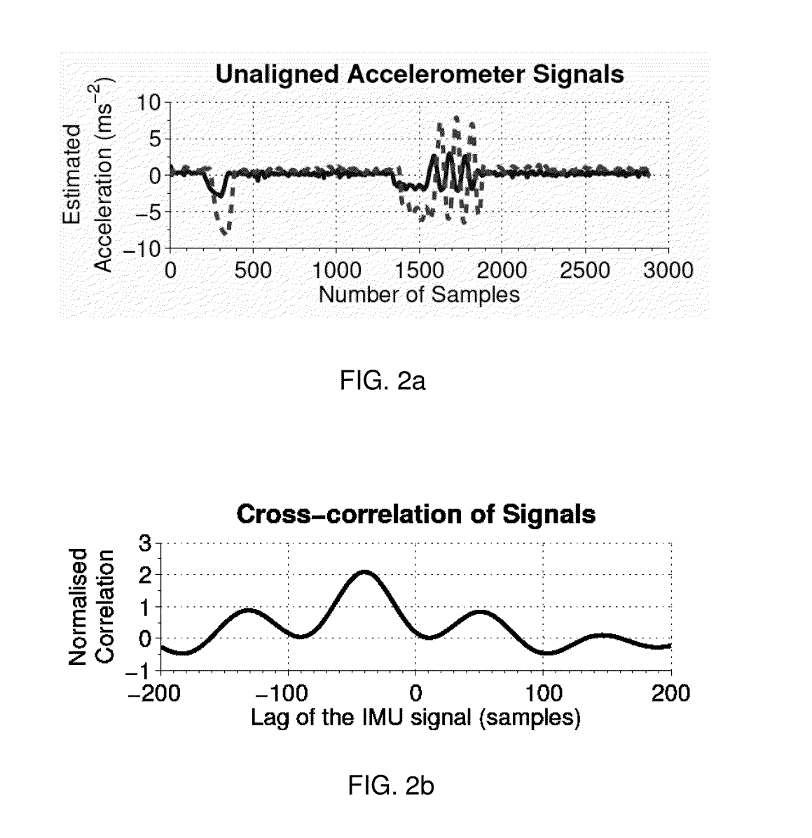

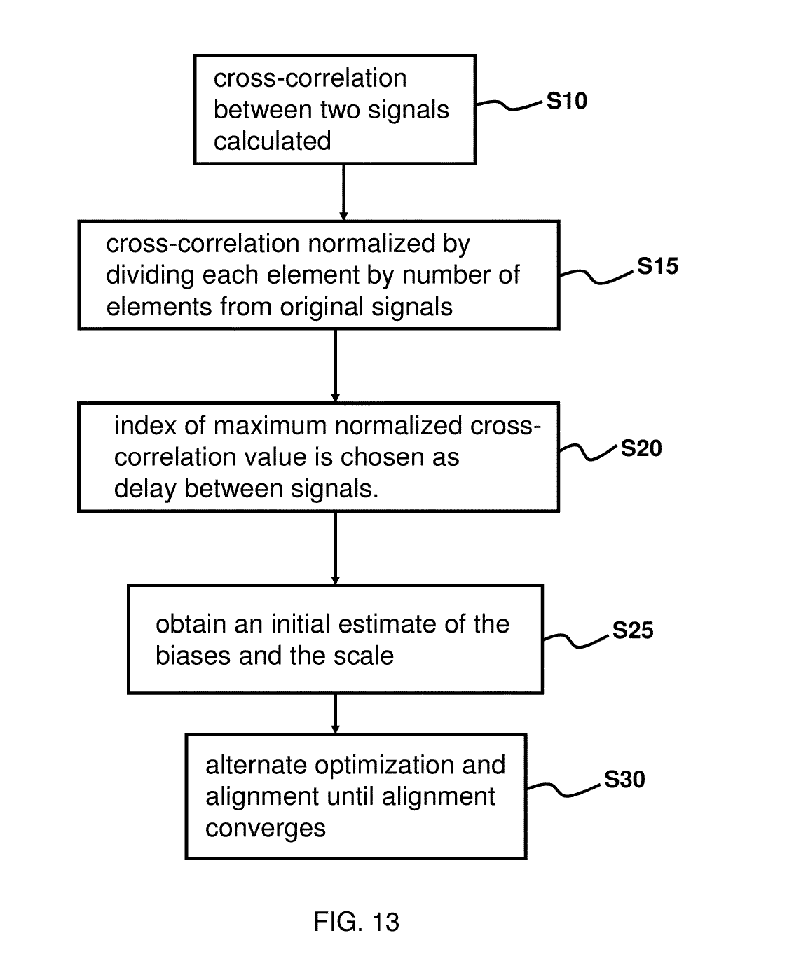

An optimum alignment between two signals (for the camera and the IMU, respectively) can be found in a temporal alignment method as follow as shown in FIG. 13: In step S10, a cross-correlation between the two signals is calculated. In step S15, the cross-correlation is then normalized by dividing each of its elements by the number of elements from the original signals that were used to calculate it, as shown also in FIG. 2b. In step S20, the index of the maximum normalized cross-correlation value is chosen as the delay between the signals. In step S25, before aligning the two signals, an initial estimate of the biases and the scale can be obtained using an Equation 5 (to be further described below). These values can be used to adjust the acceleration signals in order to improve the results of the cross-correlation between the camera and the IMU signals. In step S30, the optimization and alignment of the two signals are alternated until the alignment converges, as shown in FIG. 2b, which shows the result of the normalized cross correlation of the camera and the IMU signals. In FIG. 2a, the solid line curve represents data for the camera acceleration scaled by an initial solution. Meanwhile, the dashed line curve represents data for the IMU acceleration. In the illustrated embodiment as shown in FIG. 2b, the delay or lag of the IMU signal (samples) that gives the best alignment of the two signals is approximately 40 samples.

Due to the fact that above alignment method in the illustrated embodiment for finding the delay between two signals can suffer from noisy data for smaller motions (which is of shorter time duration), contribution of gravity is therefore adopted therein because reintroducing gravity has at least two advantages: (i) it behaves as an anchor to significantly improve the robustness of the temporal alignment of the IMU and the camera video capture, and (ii) it allows the removal of the black box gravity estimation built into smart devices configured with the IMUs. In this embodiment, instead of comparing the estimated camera acceleration and the linear IMU acceleration, the gravity vector, g, is added back into the estimated camera acceleration and is compared with the raw IMU acceleration (which already contains a raw gravity data). Before superimposing the gravity data, the raw gravity data needs to be oriented with the IMU acceleration data, much like the camera/vision acceleration data. An expression for Ĝ is defined as follow:

$$\hat{G} = ( \begin{matrix}{g}^{T} {R}_{1}^{V} \\ ⋮ \\ {g}^{T} {R}_{F}^{V}\end{matrix} ) \qquad ( 4 )$$

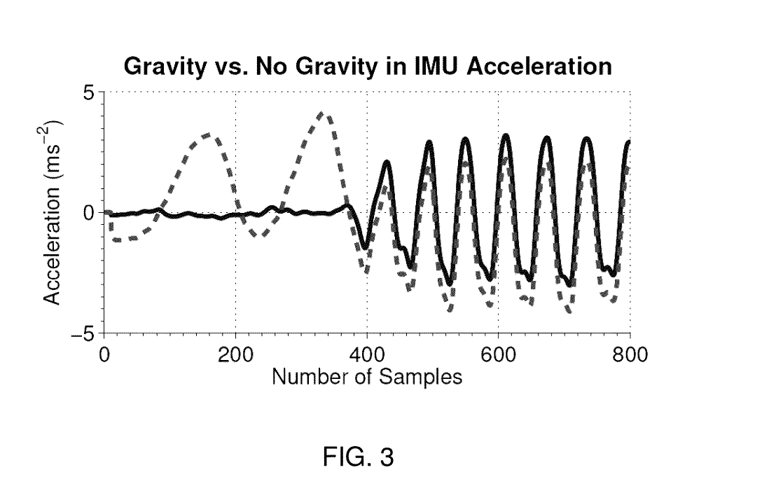

As shown in FIG. 3, the large, low frequency motions of rotation of the smart device through the gravity field help anchor the temporal alignment thereof. In addition, the solid line curve shows the IMU acceleration without gravity, while the dashed line shows the raw IMU acceleration with gravity. Since the accelerations are in the camera reference frame, the reintroduction of gravity thus essentially captures the pitch and roll of the smart device. The dashed line in FIG. 3 shows that the gravity component is of relatively large magnitude and low frequency. This can improve the robustness of the temporal alignment dramatically. If the alignment of the vision scene with gravity is already known, it can simply be added to the camera acceleration vectors before performing the scale estimation. However, the above argument of the minimum objective function includes a gravity term g so as to be able to be applicable in a wider range of applications or scenarios as shown in an Equation 5 below:

$${argmin }_{s , b , g} η \{ s {\hat{A}}_{V} + 1 ⊗ {b}^{T} + \hat{G} - {DA}_{I} {R}_{I} \} \qquad ( 5 )$$

where the gravity term g is linear in Ĝ. In this embodiment, Equations 4 and 5 do not attempt to constrain gravity to its known default constant value. This is addressed by alternating between solving for {s,b} and g separately where g is normalized to its known magnitude when solving for {s,b}. This is iterated until the scale estimation process converges. All constants, variables, operators, matrices, or entities included in Equations 4 and 5 which are the same as those in Equations 1-3 are defined in the same manner, and are therefore omitted for the sake of brevity.

When recording video and IMU samples offline, it is useful to know when one has obtained sufficient samples. Therefore, one task to perform is to classify which parts of the signal are useful by ensuring it contains enough excitation. This is achieved by centering a window at sample, n, and computing the spectrum through short time Fourier analysis. A sample is classified as useful if the amplitude of certain frequencies is above a chosen threshold. The selection of the frequency range and thresholds is investigated in conducted experiments described herein below. Note that the minimum size of the window is limited by the lowest frequency one wishes to classify as useful.

In conducted experiments performed under the conditions and steps defined under the embodiment of present invention as described herein below, sensor data have been collected from iOS and Android devices using custom built applications. The custom-built applications record video while logging IMU data at 100 Hz to a file. These IMU data files are then processed in batch format as described in the conducted experiments. For all of the conducted experiments, the cameras' intrinsic calibration matrices have been determined beforehand, and the camera is pitched and rolled at the beginning of each sequence to help provide temporal alignment of the sensor data as done in the embodiments. The choice of η{ } depends on the assumptions of the noise in the data. It is found that good empirical performance with the l2-norm² (Equation 6, described herein below) being used as the penalty function is obtained in many of the conducted experiments according to the first embodiment. However, alternate penalty functions such as the grouped-l1-norm according to the second embodiment that are less sensitive to outliers has also being tested in other conducted experiments serving as comparison.

Camera motion is gathered in three different methods described as follow: (i) tracking a chessboard of unknown size, (ii) using pose estimation of a face-tracking algorithm, and (iii) using the output of an SfM algorithm. In the above method under (ii), the pose estimation of a face-tracking algorithm is described by Cox, M. J. et al. in “Deformable model fitting by regularized landmark mean-shift.” International Journal of Computer Vision (IJCV) 91(2)(2011) 200-215.

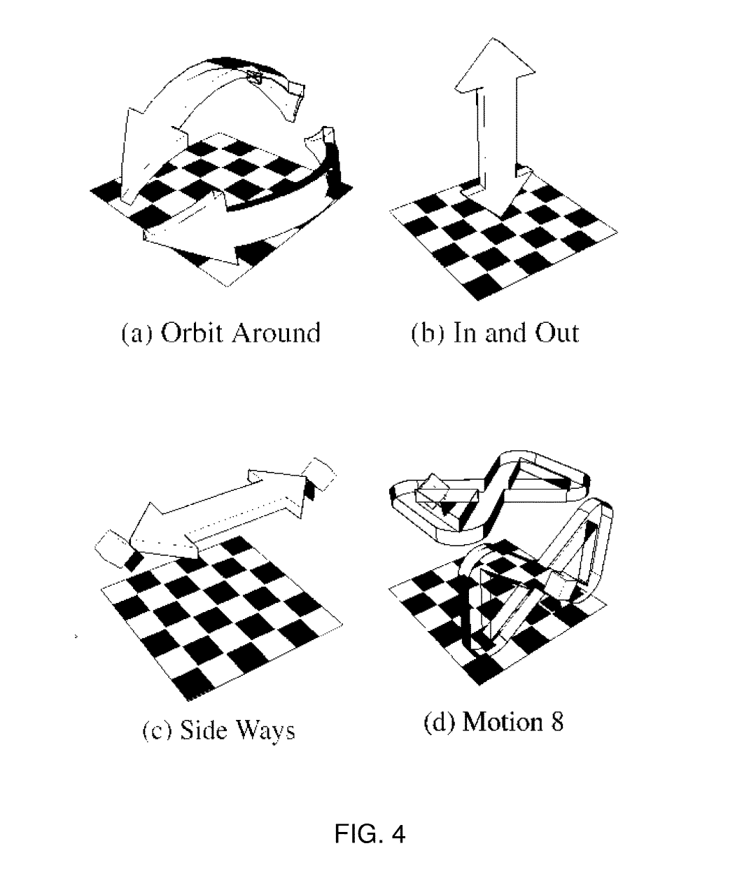

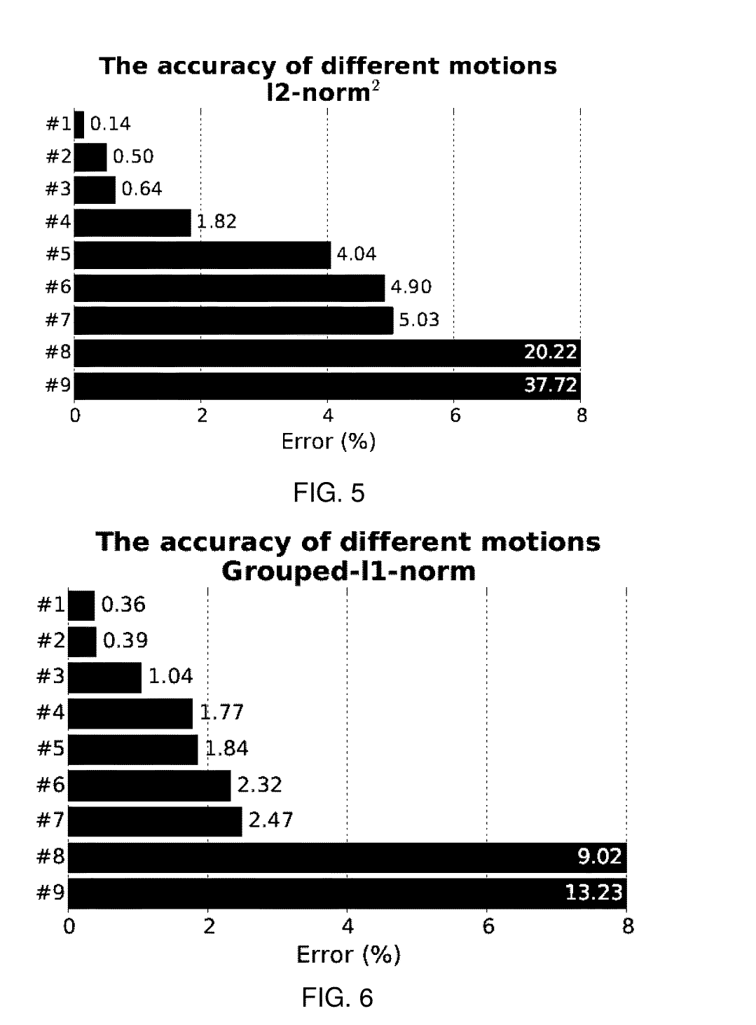

On an iPad, the accuracy of the scale estimation method described in the first embodiment in which the smart device is operated under moving and rotating in 3D space and the types of motion trajectories that produce the best results has been studied. Using a chessboard allows the user to be agnostic from objects and the obtaining of the pose estimation from chessboard corners is well researched in the related art. In a conducted experiment, OpenCV's findChessboardCorners and solvePnP functions are utilized. The trajectories in these conducted experiments were chosen in order to test the number of axes that need to be excited, the trajectories that work best, the frequencies that help the most, and the required amplitude of the motions, respectively. The camera motion trajectories can be placed into the following four motion trajectory types/categories, which are shown in FIGS. 4(a)-4(d):
(a) Orbit Around: The camera remains the same distance to the centroid of the object while orbiting around (FIG. 4(a));
(b) In and Out: The camera moves linearly toward and away from the object (FIG. 4(b));
(c) Side Ways: The camera moves linearly and parallel to a plane intersecting the object (FIG. 4(c));
(d) Motion 8: The camera follows a figure of 8 shaped trajectory—this can be in or out of plane (FIG. 4(d)).
   In each of the trajectory type, the camera maintains visual contact at the subject. Different motion sequences of the four trajectories were tested. The use of different penalty functions, and thus different noise assumptions, is also explored. FIG. 5 shows the accuracy of the scale estimation results when the l2-norm² (Equation 6) is used as the penalty function in a conducted experiment. FIG. 6 shows the accuracy of the scale estimation results when the grouped-l1-norm (Equation 7) is used as the penalty function. There is an obvious overall improvement when using the grouped-l1-norm as the penalty function, thereby suggesting that a Gaussian noise assumption is not strictly observed.
l2-norm² is expressed as follow in Equation 6:

$${η}_{𝓁2} \{ X \} = {\sum }_{i = 1}^{F} {‖ {x}_{i} ‖}_{2}^{2} \qquad ( 6 )$$

grouped-l1-norm is expressed as follow in Equation 7:

$${η}_{𝓁2𝓁1} \{ X \} = {\sum }_{i = 1}^{F} {‖ {x}_{i} ‖}_{2} \qquad ( 7 )$$

Where X is defined as follows in Equation 8:

X=[x₁, . . . , x_{F}]^{T} (8)

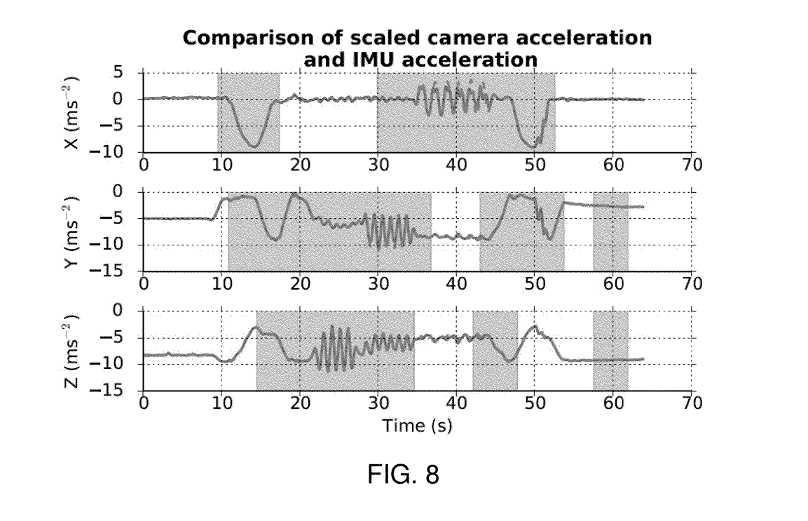

Both FIGS. 5 and 6 show that, in general, it is best to excite all axes of the smart device. The most accurate scale estimation is achieved by a combination of the following two trajectory types, namely: the In and Out (b) motion and the Sideways (c) motion (along both the x and y axes) trajectory types; and the scaled acceleration results are shown in FIG. 8.

Referring to FIG. 5, the percentage error and accuracy in scale estimations for different motions on an iPad is evaluated under l2-norm² (Equation 6) as the penalty function. Linear trajectory types are observed to be producing more accurate estimations. Identification numbers #1, #2, . . . through #9 are listed in FIG. 5 and presented under the heading “# Motions” in Table 1 below for corresponding to conducted experiments under various trajectory types as indicated by “a” for representing Orbit Around motion trajectory (FIG. 4(a)), “‘b” for representing In and Out motion trajectory (FIG. 4(b)), “c” for representing Side Ways motion trajectory type (FIG. 4(c)); and “d” for representing Motion 8 motion trajectory type (FIG. 4(d)).

TABLE 1

| | | Excitation (s) | | |
|---|---|---|---|---|
| # Motions | Frequency (Hz) | X | Y | Z |
| 1 b + c(X and Y axis) | ~1 | 20 | 30 | 45 |
| 2 b + c(X and Y axis) | ~1.2 | 35 | 25 | 70 |
| 3 b + c(X and Y axis) | ~0.8 | 10 | 7 | 5 |
| 4 b + c(X and Y axis) | ~0.7 | 10 | 10 | 10 |
| 5 b | ~0.75 | 0 | 0 | 160 |
| 6 b + c(X and Y axis) | ~0.8 | 5 | 3 | 4 |
| 7 b + c(X and Y axis) | ~1.5 | 7 | 6 | 4 |
| 8 a(X and Y axis) + b | 0.4-0.8 | 30 | 30 | 47 |
| 9 b + d(in plane) | ~0.8 | 50 | 50 | 10 |

Referring to FIG. 6, the percentage error and accuracy in scale estimations for different motion trajectories on an iPad is evaluated under grouped-l1-norm (Equation 7) as the penalty function. Linear trajectory types are observed to be producing more accurate estimations. Identification numbers are listed from #1, #2, . . . to #9 in FIG. 6 and listed under the heading “# Motions” in Table 2 below to be corresponding to various conducted experiments performed under various trajectory types as indicated by “a” for representing Orbit Around motion trajectory (FIG. 4(a)), “‘b” for representing In and Out motion trajectory type (FIG. 4(b)), “c” for representing Side Ways motion trajectory type (FIG. 4(c)); and “d” for representing Motion 8 motion trajectory type (FIG. 4(d)).

TABLE 2

| | | Excitation (s) | | |
|---|---|---|---|---|
| # Motions | Frequency (Hz) | X | Y | Z |
| 1 b + c(X and Y axis) | ~0.8 | 10 | 7 | 5 |
| 2 b + c(X and Y axis) | ~0.7 | 10 | 10 | 10 |
| 3 b + c(X and Y axis) | ~0.8 | 5 | 3 | 4 |
| 4 b + c(X and Y axis) | ~1.5 | 7 | 6 | 4 |
| 5 b + c(X and Y axis) | ~1 | 20 | 30 | 45 |
| 6 b | ~0.75 | 0 | 0 | 160 |
| 7 b + c(X and Y axis) | ~1.2 | 35 | 25 | 70 |
| 8 a(X and Y axis) + b | 0.4-0.8 | 30 | 30 | 47 |
| 9 b + d(in plane) | ~0.8 | 50 | 50 | 10 |

Based on analysis of the collected data from FIG. 6 and Table 2, there is observed to be an obvious overall improvement when using the grouped-l1-norm as the penalty function, thereby suggesting that a Gaussian noise assumption is not strictly observed in actual scenarios.

Referring to FIG. 7, the scale estimation process converges (with the addition of more data being collected) to the ground truth over time for b+c motion trajectories (In and Out in FIG. 4(b) and side ways in FIG. 4(c)) in all axes under the condition of temporally aligned camera and IMU signals. Meanwhile, referring to FIG. 7, for the sake of comparison or completeness, the error percentage of the scale estimate results is compiled under the condition of without temporally aligned camera and IMU signals.

Referring to FIG. 8, the motion trajectory sequence b+c(X,Y) excites multiple axes which increases the accuracy of the scale estimations. The multiple axes include x-axis, y-axis, and z-axis. The solid line curve indicates the scaled camera acceleration, and the dashed line indicates the IMU acceleration, and are plotted along a time duration axis, in seconds. For the sake of clarity, the time segments that are classified as producing useful motions are identified by the highlighted areas in FIG. 8.

FIG. 7 shows the scale estimation method as a function of the length of the sequence used. It shows that scale estimating process converges within an error of less than 2% with just 55 seconds of motion data. From these observations, a real-time heuristic is built for knowing when enough data has been collected. Upon inspection of the results shown in FIG. 5, the following criteria are provided for achieving sufficiently accurate results: (i) all axes should be excited with (ii) more than 10 seconds of motions of amplitude larger than 2 ms⁻².

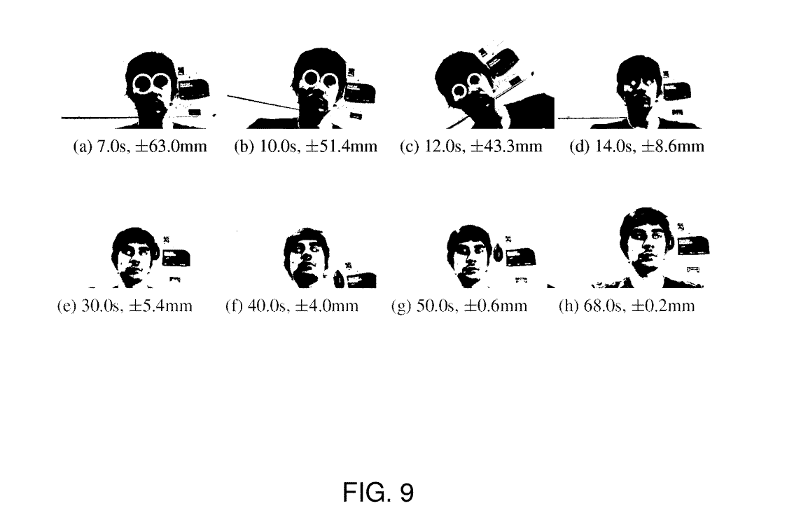

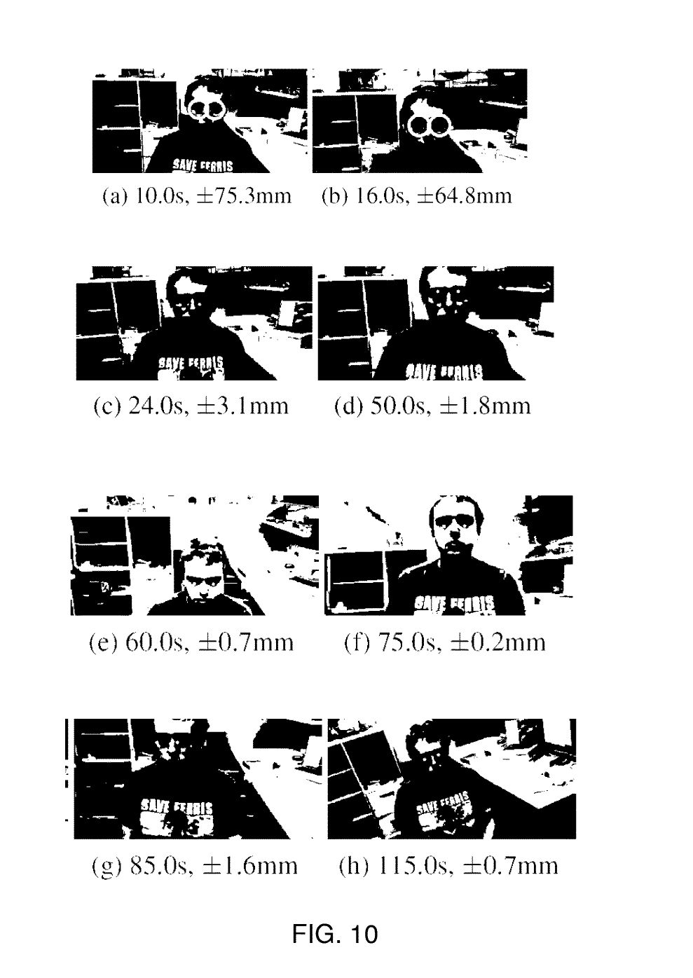

Refer to FIGS. 9 and 10 for results in conducted experiments on finding pupil distance using the scale estimation method of a third embodiment. In FIG. 9, circles are included to show the magnitude of variance in the pupil distance estimation over time. True pupil distance is 62.3 mm; a final estimated pupil distance is 62.1 mm (at 0.38% error). In FIG. 10, the tracking errors can throw off the scale estimation accuracy, but removal of these tracking error outliers by Generalized extreme studentized deviation (ESD) technique helps the estimation process to recover. The true pupil distance is 62.8 mm. Meanwhile, the final estimated pupil distance is 63.5mm (at 1.1% error).

In one conducted experiment, an ability to accurately measure the distance between one's pupils has been tested with an iPad running a software program using the scale measurement measured as presented under third embodiment. Using a conventional facial landmark tracking SDK, the camera pose relative to the face and locations of facial landmarks (with local variations to match the individual person) are respectively obtained. It has been assumed that for the duration of the sequence, the face keeps the same expression and that the head remains still. To reflect this, the facial landmark tracking SDK was modified to solve for only one expression in the sequence rather than one at each video frame. Due to the motion blur that the cameras in smart devices are prone to, the pose estimation from the face tracking algorithm can drift and occasionally fail. These errors violate the Gaussian noise assumptions. Improved results were obtained using a grouped-l1-norm, nevertheless, however it is found through conducted experiment that even better performance can be obtained through the use of an outlier detection strategy in conjunction or combination with the canonical l2-norm² penalty function, and this strategy is considered to be a preferred embodiment.

FIG. 9 shows the deviation of the estimated pupil distance from the true value at selected frames from a video taken on an iPad. With only 68 seconds of collected data, algorithm developed under the third embodiment of present invention can measure pupil distance with sufficient accuracy. FIG. 10 shows a similar sequence for measuring pupil distance on a different person. It can be observed that the face tracking, and thus pose estimation, drifts occasionally. In spite of this, the scale estimation process is still able to converge over time.

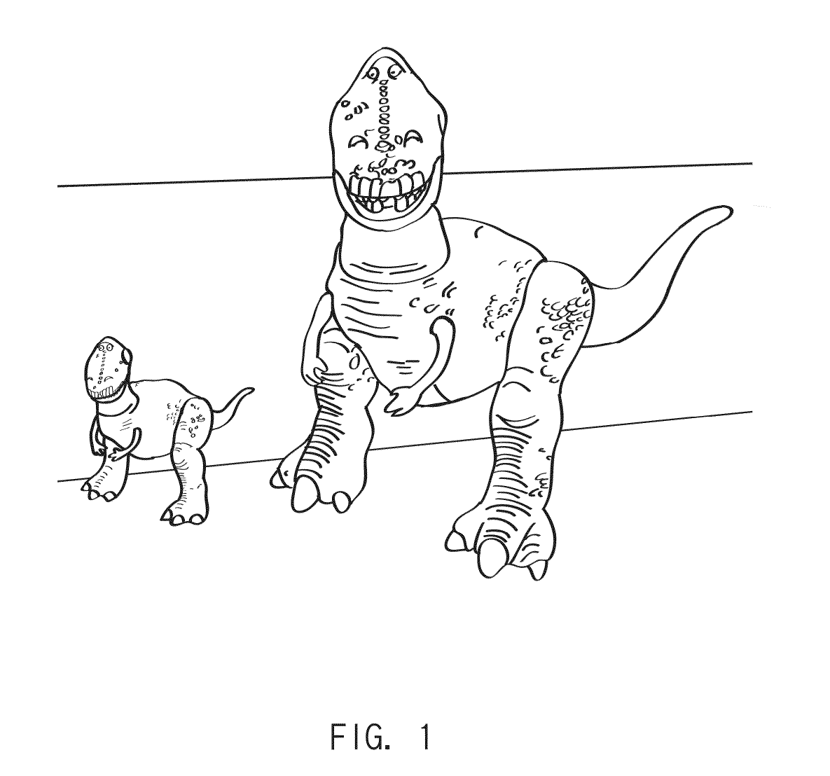

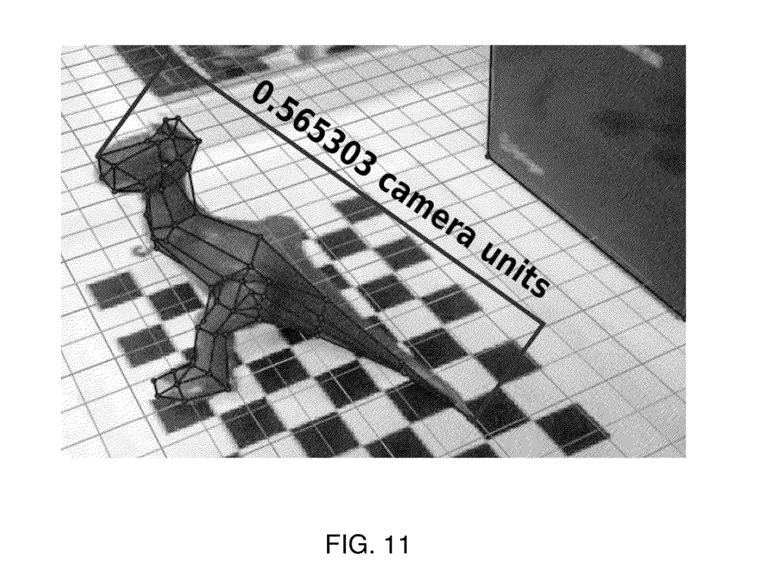

In another conducted experiment, SfM is used to obtain a 3D scan of an object using an Android® smartphone. The estimated camera motion from this conducted experiment is used to evaluate the metric scale of the vision coordinates. This is then used to make metric measurements of the virtual object which are compared with those of the (original) actual physical object. The results of these 3D scans can be seen in FIG. 11 where a basic model for the virtual object was obtained using VideoTrace developed by Australian Centre for Visual Technologies at the University of Adelaide, and being commercialized by Punchcard Company in Australia. The dimensions estimated by the algorithm developed under the third embodiment are within 1% error of the real/true values. This is sufficiently accurate to help a toy classifier to disambiguate the two dinosaur toys shown in FIG. 1. In FIG. 11, a real physical length of the toy Rex (a) is compared with the length of the 3D reconstruction of the toy Rex scaled by the algorithm of the third embodiment (b). Video image capture sequences are then recorded on an Android smartphone. Measuring of the real toy Rex gives a measurement of 184 mm in length from the tip of the nose to end of the tail thereof. Measuring of the virtual toy Rex gives a measurement of 0.565303 camera units, which can be converted to be 182.2 mm (using estimated scale=322.23). Based on the results of the conducted experiment, the accuracy is about 1% error.

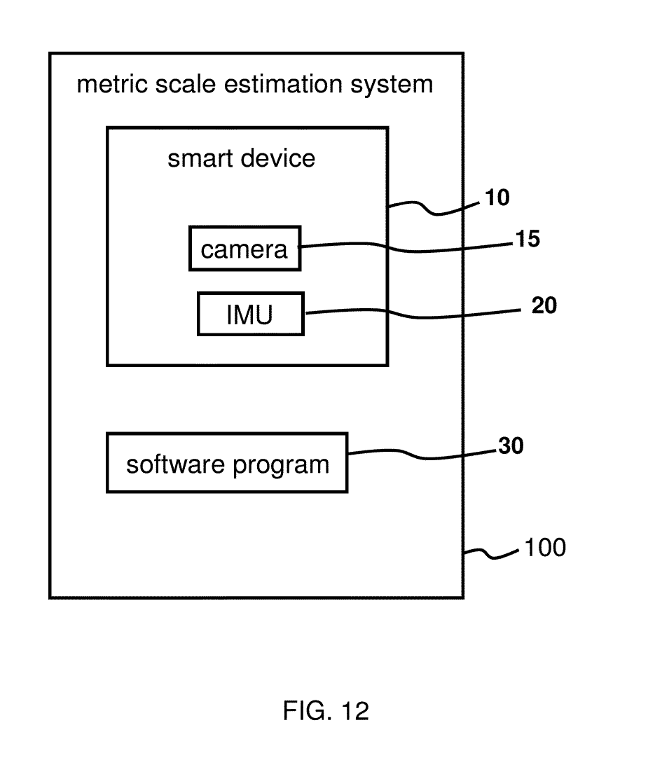

Referring to FIG. 12, according to a fourth embodiment of present invention, a batch metric scale estimation system 100 capable of estimating a metric scale of an object in 3D space includes a smart device 10 configured with a camera 15 and an IMU 20, a software program 30 comprising an algorithm to obtain camera motion from output of a SfM algorithm, is shown. The software program 30 can be in the form of an app that is downloaded and installed onto the smart device 10. The camera 15 can be at least one monocular camera. The SfM algorithm can be a conventional market available SfM algorithm. The algorithm for obtaining camera motion further includes a real-time heuristic algorithm for knowing when enough device motion data has been collected to ensure that an accurate measurement of scale can be obtained. The method to temporally align the camera signals and the IMU signals for processing as described under the first or second embodiments can also be integrated into the scale estimation system 100 of the illustrated embodiment. The optimum alignment between the two signals for the camera 15 and the IMU 20, respectively can be obtained using the temporal alignment method as described in the first and second embodiments, respectively. Meanwhile, the gravity data component for the IMU 20 is included for usage to improve the robustness of the temporal alignment of the IMU data and the camera video capture data, and to overcome the limitations imposed by having noisy IMU data. In the illustrated embodiments, all of the necessary data that is required from the vision algorithm is the position of the center of the camera 15, and the orientation of the camera 15 in the scene. In addition, the IMU 20 just requires to obtain acceleration data, and can be a 6-axis motion sensor unit, comprising of 3-axis gyroscope and 3-axis accelerometer, or a 9-axis motion sensor unit, comprising of 3-axis gyroscope, 3-axis accelerometer, and 3-axis magnetometer. In other embodiments, the scale estimation system and the scale estimating method can include of other sensors, such as for example, audio sensor for sensing sound from phones, a rear-facing depth camera, a rear-facing stereo camera to help to more rapidly define the scale estimate process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. Furthermore, the term “a”, “an” or “one” recited herein as well as in the claims hereafter may refer to and include the meaning of “at least one” or “more than one”.

What is claimed is:

1. A scale estimating method of an object for smart device, comprising:
configuring the smart device with an inertial measurement unit (IMU) and a monocular vision system wherein the monocular vision system having at least one monocular camera to obtain a plurality of SfM camera motion matrices;
performing temporal alignment for aligning a plurality of video signals captured from the at least one monocular camera with respect to a plurality of IMU signals from the IMU, wherein the IMU signals includes a plurality of gravity data, the video signals includes a gravity vector, the video signals are a plurality of camera accelerations, and the IMU signals include a plurality of IMU acceleration measurements, the IMU acceleration measurements are spatially aligned with the camera coordinate frame; and
performing a virtual 3D reconstruction of the object in a 3D space by producing a plurality of motion trajectories using the at least one monocular camera to be converging towards a scale estimate of the 3D structure of the object in the presence of noisy IMU signals, wherein a real-time heuristic algorithm is performed for determining as to when enough motion data for the smart device has been collected.

2. The scale estimating method as claimed in claim 1, wherein a plurality of IMU data files comprising of the IMU signals are processed in batch format.

3. The scale estimating method as claimed in claim 1, further including a conventional facial landmark tracking SDK, together being used to obtain one or more pupil distance measurement.

4. The scale estimating method as claimed in claim 3, wherein a plurality of tracking error outliers are removed by Generalized Extreme Studentized Deviation (ESD) technique, the conventional facial landmark tracking SDK is modified to solve for only one expression in a video sequence rather than one expression at each video frame, a camera pose relative to the face and locations of facial landmarks are respectively obtained.

5. The scale estimating method as claimed in claim 1, wherein the scale estimation accuracy in metric reconstructions is within 1%-2% of ground-truth using the monocular camera and the IMU of the smart device.

6. The scale estimating method as claimed in claim 1, wherein the smart device is moving and rotating in the 3D space, the SfM algorithm returns the position and orientation of the camera of the smart device in scene coordinates, and the IMU acceleration measurements from the smart device are in local, body-centric coordinates.

7. The scale estimating method as claimed in claim 1, further comprising defining an acceleration matrix (A_{V}) in an Equation 1:
$${A}_{V} = ( \begin{matrix}{a}_{1}^{x} & {a}_{1}^{y} & {a}_{1}^{z} \\ ⋮ & ⋮ & ⋮ \\ {a}_{F}^{x} & {a}_{F}^{y} & {a}_{F}^{z}\end{matrix} ) = ( \begin{matrix}{Φ}_{1}^{T} \\ ⋮ \\ {Φ}_{F}^{T}\end{matrix} ) \qquad ( 1 )$$
wherein each row is the (x,y,z) acceleration for each video frame captured by the camera, and defining a body-centric acceleration Â_{V} in an Equation 2:
$${\hat{A}}_{V} = ( \begin{matrix}{Φ}_{1}^{T} {R}_{1}^{V} \\ ⋮ \\ {Φ}_{F}^{T} {R}_{F}^{V}\end{matrix} ) \qquad ( 2 )$$
where F is the number of video frames, R^{V}ₙ is the orientation of the camera in scene coordinates at an nth video frame, an N×3 matrix of a plurality of IMU acceleration measurements, A_{I}, is formed, where Nis the number of IMU acceleration measurements.

8. The scale estimating method as claimed in claim 7, wherein the camera and the IMU are disposed on a same circuit board, an orthogonal transformation R_{I} is being performed, that is determined by the API used by the smart device, the rotation is used to find the IMU acceleration in local camera coordinates, wherein an objective in an Equation 5 is to be solved until the scale estimation converges, where a gravity term g is linear in Ĝ, η{ } is a penalty function, and the penalty function is l2-norm² or grouped-l1-norm, b is constant bias, Â_{V} is body-centric acceleration defined such that each row of a is the (x,y,z) acceleration for each video frame captured by the camera, A_{I} is a plurality of IMU acceleration measurements, R_{I} is an orthogonal transformation that is determined by the API used by the smart device, g is a gravity term:
$${argmin }_{s , b , g} η \{ s {\hat{A}}_{V} + 1 ⊗ {b}^{T} + \hat{G} - {DA}_{I} {R}_{I} \} \qquad ( 5 )$$

9. The scale estimating method as claimed in claim 8, when recording the video and IMU samples offline, centering a window at sample, n, and computing the spectrum through short time Fourier analysis, classifying a sample as useful if the amplitude of a chosen range of frequencies is above a chosen threshold, in which the minimum size of the window is limited by the lowest frequency one wishes to classify as useful.

10. The scale estimating method as claimed in claim 8, wherein the temporal alignment between the camera signals and the IMU signals, comprising the steps of:
calculating a cross-correlation between a plurality of camera signals and a plurality of IMU signals;
normalizing the cross-correlation by dividing each of its elements by the number of elements from the original signals that were used to calculate it;
choosing an index of a maximum normalized cross-correlation value as a delay between the signals;
obtaining an initial bias estimate and the scale estimate using equation 5 before aligning the two signals;
alternating the optimization and alignment until the alignment converges as shown by the normalized cross-correlation of the camera and the IMU signals, wherein the temporal alignment comprising of superimposing a first curve representing data for the camera acceleration scaled by an initial solution and a second curve representing data for the IMU acceleration; and
determining the delay of the IMU signals thereby aligning the IMU signals with respect to the camera signals.

11. The scale estimating method as claimed in claim 10, wherein a plurality of camera motions for producing the motion trajectories are obtained by tracking a chessboard of unknown size, using pose estimation of a face-tracking algorithm, or using the output of an SfM algorithm.

12. The scale estimating method as claimed in claim 11, wherein the motion trajectories include an Orbit Around, an In and Out, a Side Ways, and a Motion 8 in the 3D space, wherein the Orbit Around is having the camera to remain at the same distance to the centroid of the object while orbiting around; the In and Out is where the camera moves linearly toward and away from the object; the Side Ways is where the camera moves linearly and parallel to a plane intersecting the object; and the Motion 8 is where the camera follows a figure of 8 shaped trajectory in or out of plane; in each of the motion trajectories, the camera maintains visual contact at the subject.

13. The scale estimating method as claimed in claim 8, wherein the l2-norm² is expressed in an Equation 6, the grouped-l1-norm is expressed in Equation 7, X is defined in an Equation 8:
$$\begin{matrix}{η}_{𝓁2} \{ X \} = {\sum }_{i = 1}^{F} {‖ {x}_{i} ‖}_{2}^{2} & ( 6 ) \\ {η}_{𝓁2𝓁1} \{ X \} = {\sum }_{i = 1}^{F} {‖ {x}_{i} ‖}_{2} & ( 7 ) \\ X = {[ {x}_{1} , … , {x}_{F} ]}^{T} & ( 8 )\end{matrix}$$

14. The scale estimating method as claimed in claim 12, wherein using the In and Out and the Side ways motion trajectories for gathering IMU sensor signals including gravity and the camera signals, wherein the scale estimate process converges within an error of less than 2% with just 55 seconds of motion data.

15. The scale estimating method as claimed in claim 12, wherein SfM algorithm is used to obtain a 3D scan of an object using an Android® smartphone, an estimated camera motion is used to make metric measurements of the virtual object, where a basic model for the virtual object was obtained using VideoTrace (R), the dimensions of the virtual object are measured to be within 1% error of the true values.

16. A batch metric scale estimation system capable of estimating the metric scale of an object in 3D space, comprising:
a smart device configured with a camera and an IMU; and
a software program comprising a camera motion algorithm from output of SfM algorithm,
wherein the camera includes at least one monocular camera, the camera motion algorithm further includes a real-time heuristic algorithm for knowing when enough device motion data has been collected, wherein the scale estimation further includes temporal alignment of the camera signals and the IMU signals, which also includes a gravity data component for the IMU, data required from the vision algorithm includes the position of the center of the camera and the orientation of the camera in the scene, the IMU is a 6-axis motion sensor unit, comprising of 3-axis gyroscope and 3-axis accelerometer, or a 9-axis motion sensor unit, comprising of 3-axis gyroscope, 3-axis accelerometer, and 3-axis magnetometer.

17. The batch metric scale estimation system as claimed in claim 16, wherein the video signals includes a gravity vector, the video signals include a plurality of camera accelerations, the camera and the IMU are disposed on a same circuit board, an orthogonal transformation R_{I} is being performed, that is determined by the API used by the smart device, the rotation is used to find the IMU acceleration in local camera coordinates, wherein an objective in an Equation 5 is to be solved until the scale estimation process converges, where a gravity term g is linear in G, η{ } is a penalty function, and the penalty function is l2-norm² or grouped-l1-norm:
$${argmin }_{s , b , g} η \{ s {\hat{A}}_{V} + 1 ⊗ {b}^{T} + \hat{G} - {DA}_{I} {R}_{I} \} \qquad ( 5 )$$
